(19) United States
(12) Patent Application Publication
(10) Pub. No.: US 2009/0112888 A1
(43) Pub. Date: Apr. 30, 2009

(54) METHOD OF PROVIDING DATABASE ACCESS TO NON-PROGRAMMERS

(76) Inventors: Rand Warsaw, Monroeville, PA (US); Leigh Renninger, Pittsburgh, PA (US); Andy Meyer, Pittsburgh, PA (US)

Correspondence Address: FOX ROTHSCHILD, LLP;Pittsburgh, 2000 Market Street, 10th Floor, Philadelphia, PA, 19103, US

(21) Appl. No.: 11/923,768

(22) Filed: Oct. 25, 2007

(51) Int. Cl. G06F 17/30; G06F 3/048

(52) U.S. Cl. 707/100; 715/835; 707/E17.044

(57) ABSTRACT

An operating system independent system for enabling non-technical users to manipulate data from within large pre-existing databases with limited involvement of programmers. The system consists of a visual interface for the construction of a sequence of operations to retrieve, manipulate and store data in the databases, as well as displays of a meta-language version of the entered user commands and a natural language translation of the commands.

### FIELD OF THE INVENTION

The invention relates to computer programming languages, and is particularly applicable to the access of databases by users who are not skilled as database programmers.

### BACKGROUND OF THE INVENTION

Many organizations that rely on large databases of information employ analysts and others who can manipulate data in spreadsheet form, but who require the intervention of a database programmer every time they wish to perform large database manipulations. It can be costly for the analyst to first determine what reports or programs are required and then to engage a database programmer to locate the appropriate data within a large database or databases and write or perform the required tasks. This process can iterate as an analyst determines precisely what data is needed and to perform “what-if” scenarios.

It would therefore be desirable to allow an analyst level user to run analysis requiring database queries without the need for the intervention of a database programmer or other qualified person with database access skills.

### SUMMARY OF THE INVENTION

The present invention provides a simple method of access for a database that allows an analyst or other end-user to enter commands in a visual, front-end interface. The interface utilizes familiar user interface objects, such as push buttons or text boxes in one embodiment or a “drag and drop” paradigm in another embodiment for constructing a procedural series of instructions for retrieving and manipulating data stored in a database, providing what amounts to an accounting “scratch pad” or “flow chart” of commands. The method allows the user to perform functions similar to those that might be found on a financial calculator, and to apply those functions procedurally to data retrieved from or stored in a database. Because of the invention architecture which permits a simple front-end interface, the end user is not required to have knowledge of the structure or schema of the databases containing the input or output data, nor is knowledge of a database programming language or procedural language that permits database manipulation required.

The invention includes an operating system independent computer language which displays a visual front-end presenting database input, output and data manipulation commands as lines in a calculator style input, scratchpad or in a flowchart. The end-user creates a set of commands within this visual front-end, which can be parsed into a meta-language, and stored as a named procedure in the meta-language interpretation. The meta-language interpretation may consist of an interpretation of the command set entered by the user at any level of abstraction, including merely storing the user's raw input to the user input screens.

Subsequent copying, renaming, editing and application of these sets of commands is possible. These commands, whether stored in a meta-language or as raw input, are then interpreted real-time against a defined set of data from an existing database or databases. This process may be iterated as many times as the end-user wishes to obtain the desired results. The end user can apply these procedures against different data sets, which may include a portion or all of one or more databases. The output of these calculations can be provided as a report, written to files, displayed on a display device such as a CRT or written into tables or dynamic tables in a database. The output of these calculations can be compared to the output of other calculations or compared to other data. Comparisons can involve individual differences, group statistics and histogram displays.

The language includes basic arithmetic, related commands and database reads and writes. Additional commands could include, without limitation, Boolean, conditional, date, financial or scientific functions, and other database manipulations.

Database access requires that before an end-user uses the commands, a power-user (a database administrator or programmer), who has the appropriate operating system and database security permissions and knowledge, creates a table of database access paths and permissions and installs all required software. For successful database access, it is necessary for the power-user to at least create database connections that would allow the end-user to retrieve information from the database or databases.

The user interface is a program for translating end-user input into a meta-language, storing the meta-language, retrieving stored meta-language and interpreting the meta-language. Interpreted meta-language resolves into commands for retrieving data from the database and for performing calculations in a translator, executable, database instruction, database procedure, SQL or other well-defined language. These functions may be distributed across many different software programs on many different computers.

The user interface calculates each line of the procedure specified by the end-user, one record at a time, or one line at a time across all relevant, uniquely identified records and places the results of the calculations in a buffer, table or database dynamic storage for retrieval by other lines. The user interface can also cause the outputting of data to a database table, database dynamic storage, flat file, spreadsheet or other typical program output medium. One aspect of the present embodiment of the invention allows the commands to be saved for processing either immediately or at a later time against a portion of or all of an existing database or databases. The end-user is not required to have a detailed knowledge of the database structure, location or access language. Rather, using the invention, a so-called “power-user” can provide the input to set up the program to allow access to an existing database or databases. The end-user can then use the commands to retrieve, manipulate, analyze and store data to and from the database(s). This can be done quickly and conveniently utilizing a familiar interface which forms line-by-line procedural calculations using for instance a push button, calculator, or scratch pad front-end, or a drag and drop front end resembling a flowchart.

### BRIEF DESCRIPTION OF THE DRAWINGS

FIG. 1 shows an overview of the portion of the system used, in one embodiment, for entering user commands.

FIG. 1a shows a set of user commands being entered into the embodiment of the invention shown in FIG. 1 and a meta-language translation being stored in storage 400.

FIG. 2 shows the portion of the system, in an embodiment, used for the execution of the previously entered command set.

FIG. 2a provides a specific example, in one embodiment, of the execution of a set of user entered commands.

FIG. 3 is a representation of the storage of the results, in one embodiment, of the execution of a set of user input commands.

FIG. 4 shows an input screen from a preferred embodiment of the invention using text boxes for user input fields for a simple mathematical operation.

FIG. 5 shows an input screen from a second embodiment of the invention utilizing a drag and drop input method showing a series of multiplication commands and a database write.

FIG. 6 shows a representation of a window showing a natural language translation of the commands previously entered.

FIGS. 7-12 show a prototype of a screen wherein data is loaded in to a particular line of the user entered command set.

FIGS. 13-15 and 17-18 show a prototype screen for the entry of a mathematical operation.

FIGS. 16 and 19 show a prototype input screen for the input of a “from-to” math operation.

FIG. 20 shows a prototype input screen for a mathematical rounding operation.

FIG. 21 shows a meta-language representation of the commands entered in FIGS. 7-20.

FIG. 22 is a prototype screen showing storage of the meta-language translation of the user's input commands as stored in a database table.

FIG. 23 is a prototype screen showing a natural language translation of the commands entered in FIGS. 7-20.

FIG. 24 is a prototype screen showing an interface to the execution engine, for commands entered, shown in FIG. 2.

FIG. 25 shows an example of an input database table.

FIG. 26 shows a sample output as stored in a database table.

### DETAILED DESCRIPTION OF THE INVENTION

The invention is best understood from the following detailed description when read with the accompanying drawings.

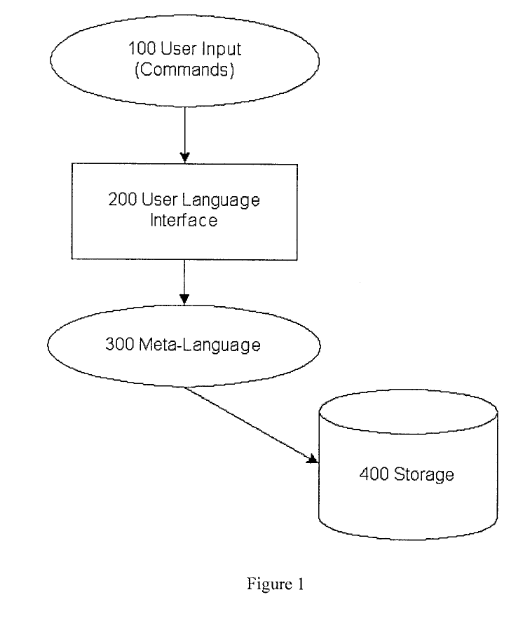

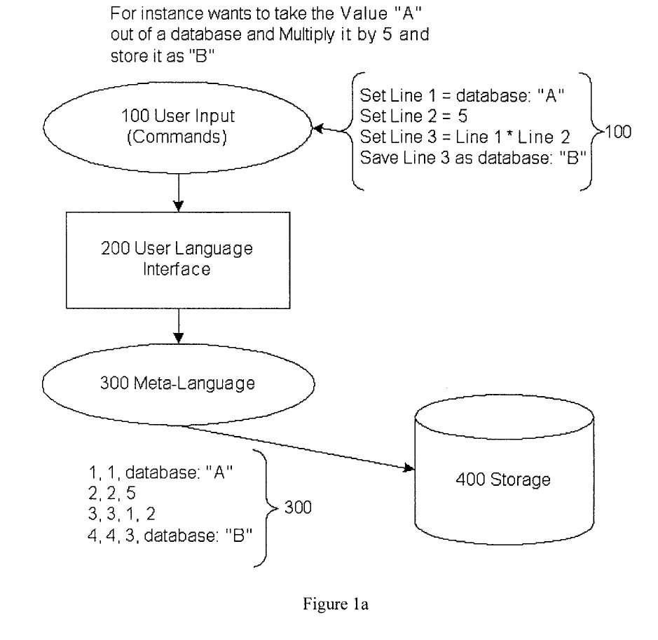

FIG. 1 depicts an overview of the input of the system wherein an end user is able to enter a series of procedural commands using a visual front-end, which simulates a calculator, scratch pad or flowchart to create a set of user-entered commands 100. The commands are then parsed and interpreted by user language interface 200, and translated to meta-language 300 by one or more computers. The user's commands are then saved to storage 400, and could be in the form of a buffer, file, document, database table, spreadsheet or other retrievable and machine readable format. The type of storage used may be dependent upon the form and level of abstraction of meta-language 300 chosen in a particular implementation of the invention.

FIG. 1a depicts storage 400 and user language interface 200 may reside on different computers and may be interconnected via a typical network well known in the art. Meta-language 300 is merely a convenient way to electronically store the series of user-entered commands 100, and may be of any convenient format. Additionally, the storage to a meta-language may be skipped with the commands stored as entered into the interface in more or less “as-is” condition or held in memory in the interface. Command translation and execution with respect to the database can occur simultaneously.

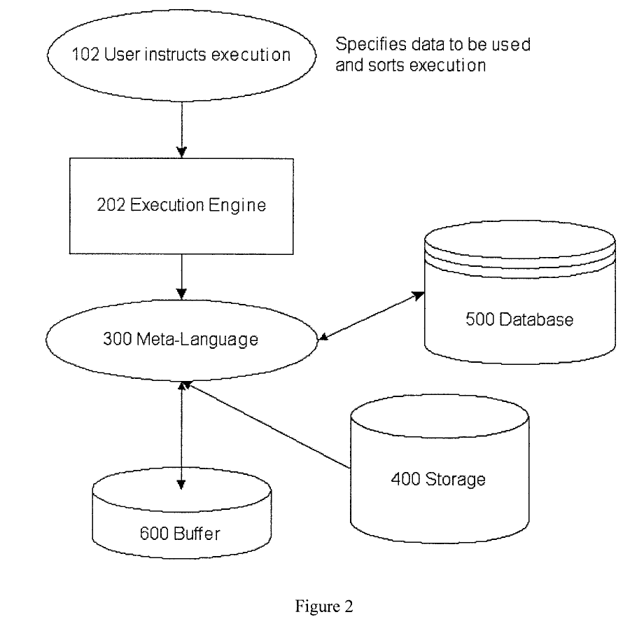

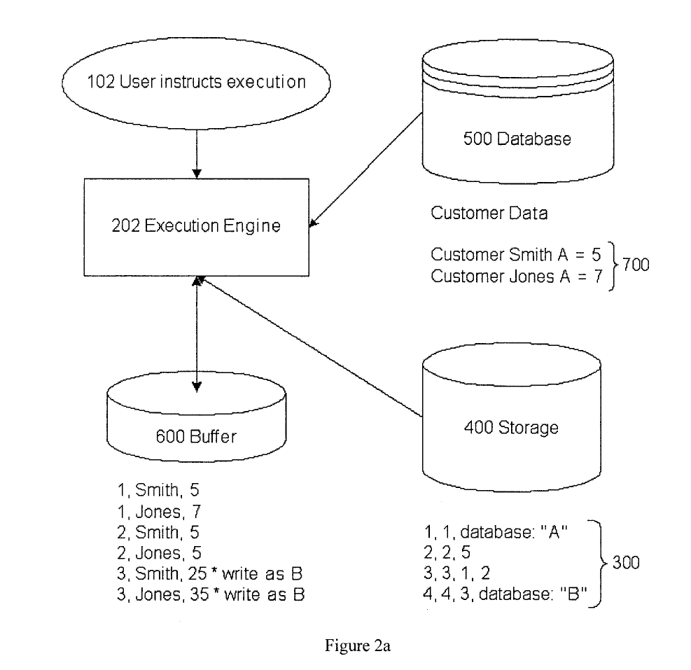

FIG. 2 depicts the invocation of meta-language 300 stored in storage 400, causing the user-entered commands 100 (from FIG. 1) to be performed on various inputs, typically data stored in database 500. The end-user, through commands 102 entered into execution engine 202, causes the retrieval of a set of data elements from database 500, typically consisting of one or more uniquely identified data records. User commands 102 entered through execution engine 202 also may specify that a named set of user commands 100 in meta-language format 300 be retrieved from storage 400. Execution engine 202 then performs a line-by-line calculation specified by meta-language 300 and stores interim results in buffer 600. Buffer 600 may be computer memory, network storage devices, optical storage, a dynamic table or table in database 500, or other data storage media of any type.

As a pre-requisite to the above, a power-user must provide the system access and links to one or more databases 500 upon which user-entered commands 100 will operate. The power user must set up the links to specific databases 500 in advance. The power user must specifically identify the fields in the tables in which the unique identifiers of the records to be selected are stored.

After the execution of meta-language 300 on the specified dataset, the results may be written to database 500. Database 500 may be the same database from which input data has been taken, or may be a physically or logically different database. User instructions 102 entered into execution engine 202 may also call for specified meta-language 300, when completed, to cause the storage of interim results of the calculation stored in buffer 600 to database 500.

It should be noted that, in FIGS. 1 and 2, the computer hosting user interface 200 and execution engine 202 need not be the same physical computer processing, storing or retrieving meta-language 300 or hosting storage 400, database 500, or buffer 600. All of these functions may be affiliated with different physical computers and databases. As previously stated, the results moved from buffer 600 in FIG. 2 may be moved to a different physical or logical database 500 from the database 500 from where the calculation input data was retrieved.

In an example provided, FIG. 1a depicts a the entry of a sample set of user-entered commands 100, in which a value ‘A’ from one or more records is retrieved from a database, multiplied by 5 and stored in a database as ‘B’. Note that the user has not yet been required to identify the data set on which this series of commands 100 is to be executed. The input data may consist of a single record in a database, or a grouping of records in a database or databases, wherein the grouping may be defined my any number of factors.

The user enters commands 100 into user interface 200 in FIG. 1, as previously described. The representation of the commands on the interface screen may read similarly to the series of command depicted as 100 in FIG. 1a. User language interface 200 then translates the user-entered commands 100 into meta-language 300, which is stored in storage 400. In this example the meta-language may look like the following:
1, 1, database: “A”
2, 2, 5
3, 3, 1, 2
4, 4, 3, database: “B”

In this example of a meta-language translation, the first number in each row acts as a row number. The second number in each line is a code for a command, for example, a code of 1 may be retrieve, 2, load data, 3, multiply and 4, store. As one of skill in the art will recognize, many more command codes that are not used in this example will likely be defined. In this short set of commands, the user specifies the retrieval of data “A” from a database in line 1. In line 2, the data “5” is loaded. In line 3, line 1 (the data from the database) is multiplied by line 2 (“5”), and in line 4, line 3 (the results of the multiplication) is stored in a database. As previously stated, any particular meta-language encoding of the user-entered commands 100 may be used, including storage of the user's raw input, which is actually a form of meta-language 300 where no processing has been performed.

FIG. 2a shows an execution of the meta-language 300 from FIG. 1a for a plurality of data records 700, which may represent, for example, customers. Meta-language 300, representing user instructions 100, is retrieved from storage 400 by execution engine 202 upon the user's instructions to execute 102. Execution engine 202 interprets meta-language 300 causing data element “A” for each record in data set 700 to be retrieved from database 500. Meta-language 300 execution continues until calculated results arrive in buffer 600. Note that it is not important conceptually, although in any particular embodiment, it may be required or preferred, if the data is retrieved in a block or on demand one consumer at a time. Similarly, it is not important conceptually, although in any particular embodiment, it may be required or preferred, that all of the calculations be performed for one record (representing a customer) before moving to the next record. For example, line 1 may be performed for all records in data set 700, then line 2 and so on, as opposed to executing lines 1-4 for one record, then for the next, and so on.

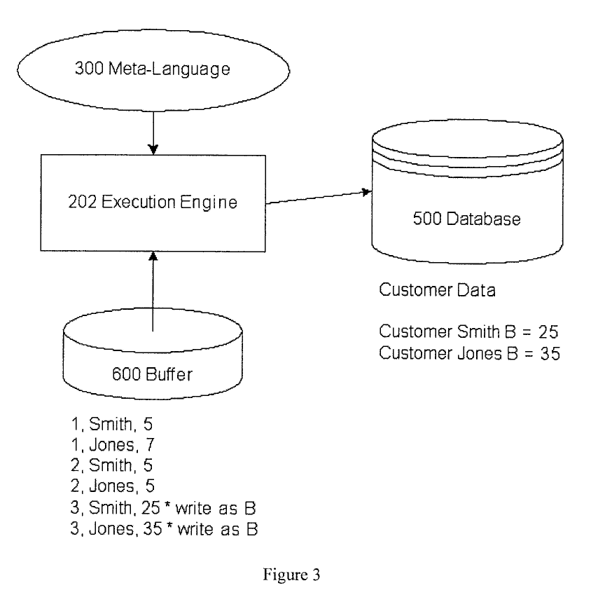

When the calculation completes, or periodically during the calculation, the data for element “B” is written to database 500. FIG. 3 is a representation of the periodic write during or after processing from buffer 600 to database 500. Execution engine 202 writes those variables specified by the user in meta-language 300 to database 500.

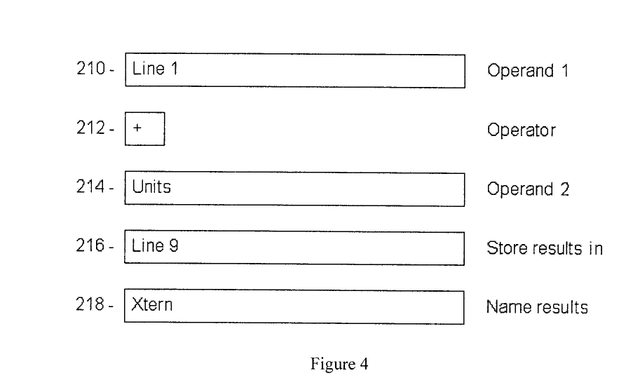

FIG. 4 is a representation of a first embodiment of the invention in which a text-box conceptualization of a calculator is used for user language interface 200. The text-box/calculator represents the entry of a single line in the user's entered set of commands. The first entry represents an operand 210 of a calculation. In this case, the value of “Line 1” was previously input or set in a prior calculation, and refers to the results of any calculation or loading of data that occurred in line 1 of the user's entered set of commands. The next entry is the operator 212, in this case, “+” signifying addition. The next line represents the other operand 214 of the calculation. In this case, “Units” is the result of a calculation or loading of data performed in a prior line, which was labeled “Units” for ease of use. The results of the calculation 216 are to be put in the 9th step or line of the procedural calculation and are assigned the name 218 of “Xtern”.

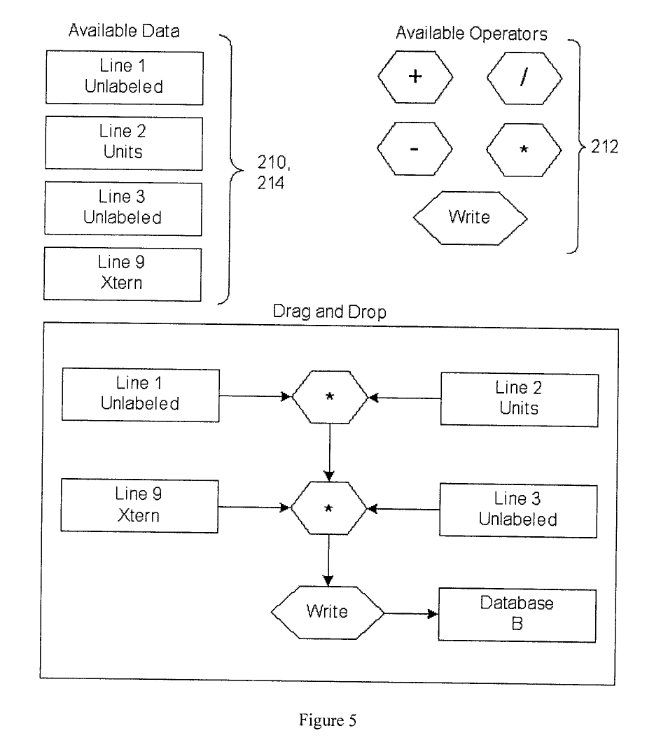

FIG. 5 represents a second embodiment of the invention, which utilizes a drag and drop style interface as user language interface 200. Operators and operands are dropped in a graphical user interface and inter-connected with procedural arrows. Note that the calculation specified in FIG. 5 is the same calculation specified in FIG. 4.

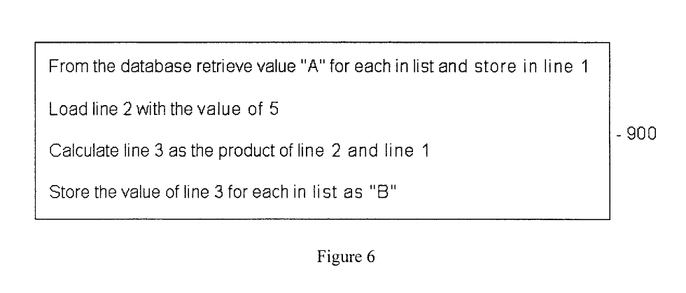

FIG. 6 represents an optional component of user interface 200 showing a natural language version of the commands entered by the user into either the text-box/calculator version user language interface 200, shown in FIG. 4, or the drag and drop version of user language interface 200, shown in FIG. 5. The natural language version of the user input commands 100, when displayed, serves as a tool for the user to verify that the commands entered are doing what the user wants.

The next several figures show an actual implementation of the system. The implementation was customized for use by a utility provider in calculating various rates that customers should be charged for an energy commodity. This calculation could be run to check billing system programming or used to calculate values in consumers' utility bills.

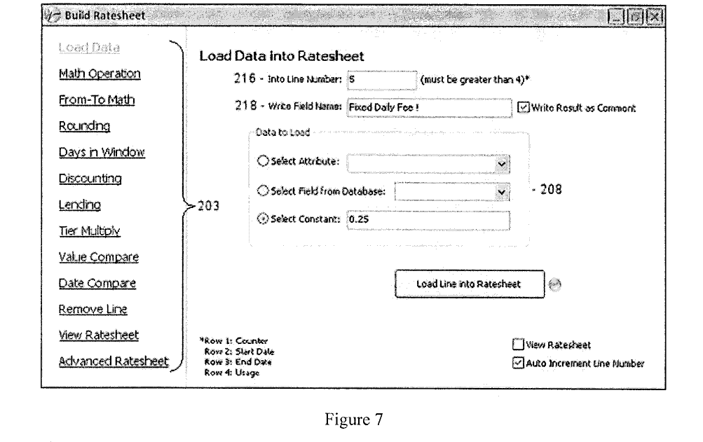

FIG. 7 is a sample screen of the main command input window of the embodied invention depicting a prototype implementation of the concepts presented in FIG. 1, wherein an end-user enters a series of user-entered commands 100 employing a visual user language interface 200. The calculations are parsed and interpreted immediately by user language interface 200, with commands thereafter being translated to meta-language 300. Meta-language 300 is written to storage 400, which, as previously discussed, could be a file, document, database table, spreadsheet or other retrievable and machine readable format. Storage 400 and user language interface 200 may reside on different computers and may communicate with each other over a common network connection.

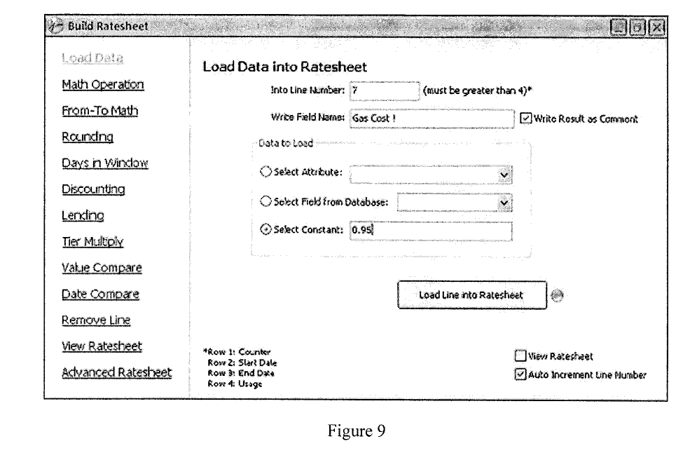

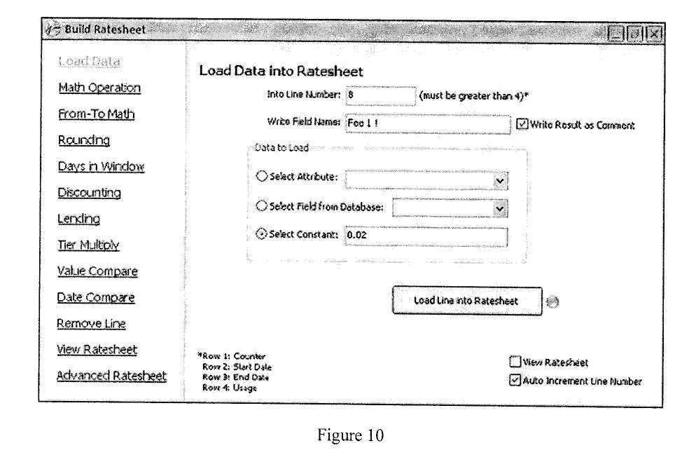

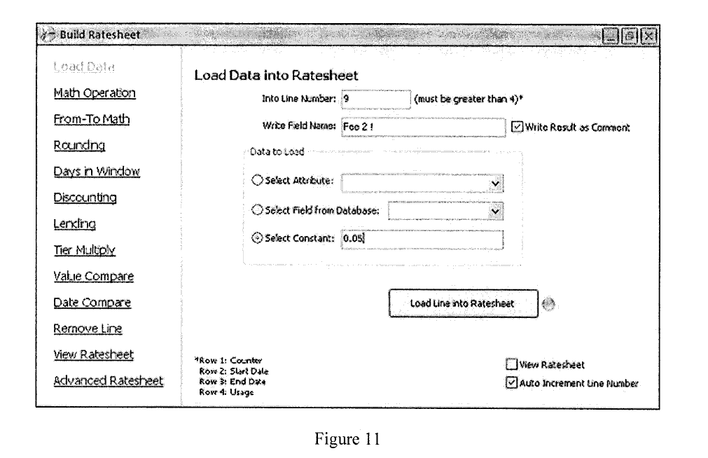

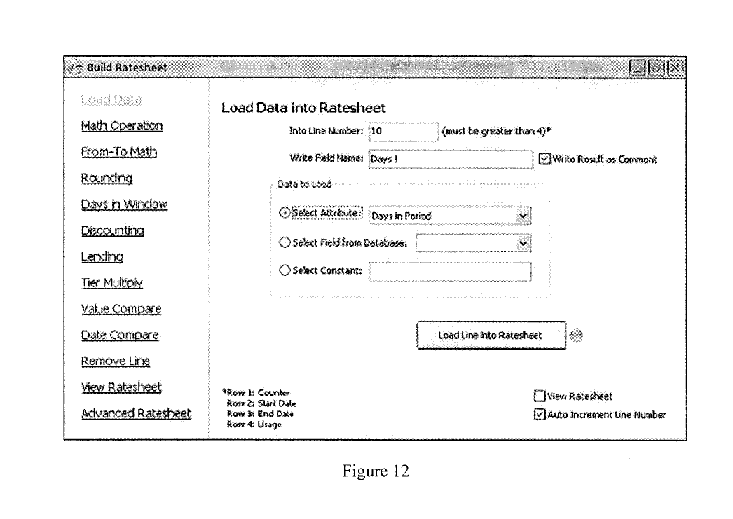

FIGS. 7-20 are sample screens depicting a prototype implementation of the conceptual screen shown in FIG. 4 wherein the user builds a series of data loading and procedural commands 100. In this prototype implementation (other implementations may or may not have this feature), most screens for the entering of user commands will have a left hand pane 203 which allows the user to select which type of command is to be entered. The selection mechanism may be, for example, a series of hyperlinks, push buttons, radio buttons, text boxes, menus, pull downs, pass over links, windows or any other user interface widget convenient for this purpose.

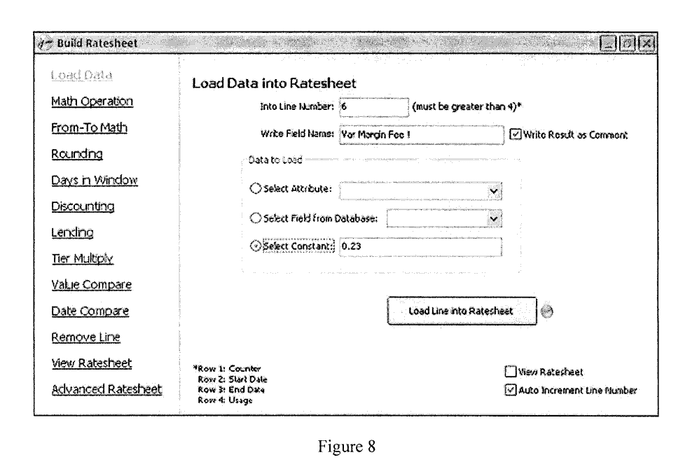

FIGS. 7-12 depict construction of a series of commands loading constant values into specific lines of the scratch pad instructions. To load data, the screen is selected by selecting the “Load Data” hyperlink from the left hand panel 203 of the screen. As an example of the use of this screen, in FIG. 7, text box 216, indicates that line 5 of the calculation is to be loaded with the constant value 0.25. The user wishes to refer to this constant as “Fixed Daily Fee” in the stored output, and enters that name in text box 218. In box 208, the user specifies that data or the source of that data, which may be, in this example embodiment, an attribute, a field from a database or a constant. Several other constants are loaded in a similar manner in lines 6-10 in FIGS. 8-12. In this particular embodiment, calculation lines 1-4 have been pre-set by the power user at software installation to correspond to data in standard database tables.

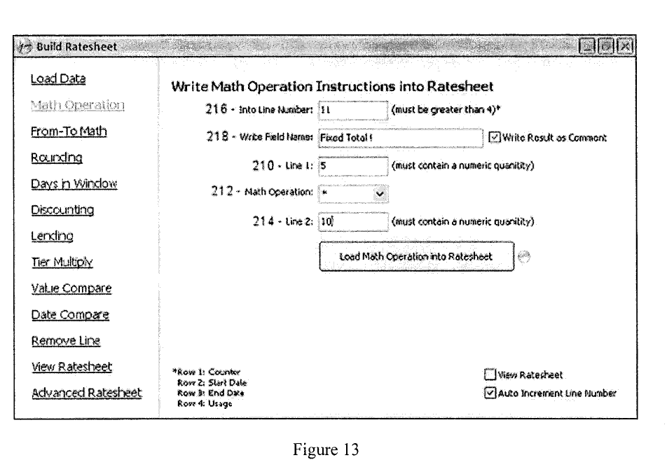

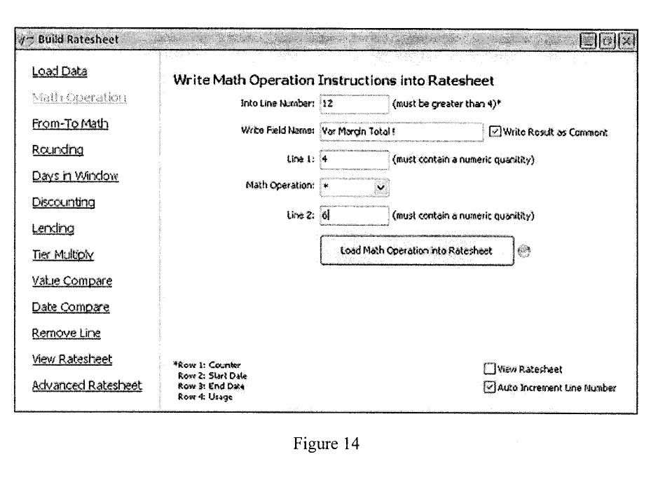

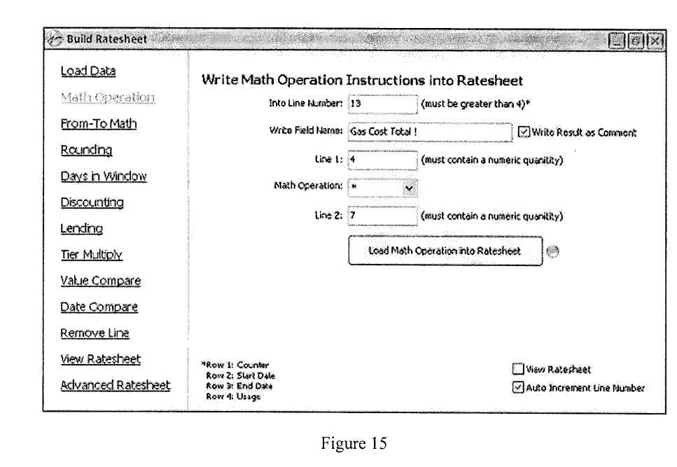

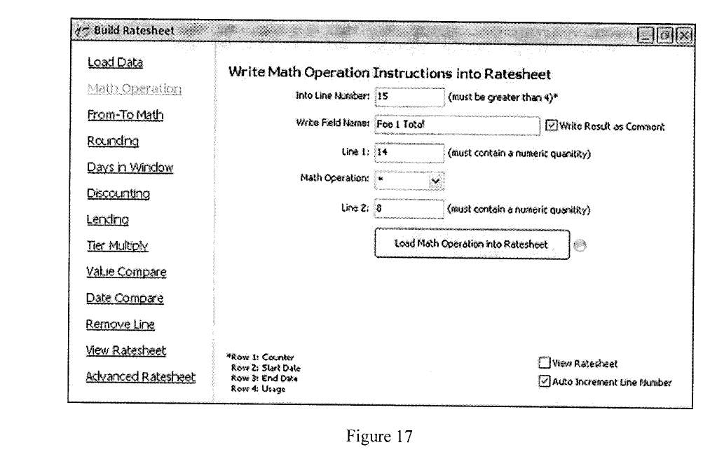

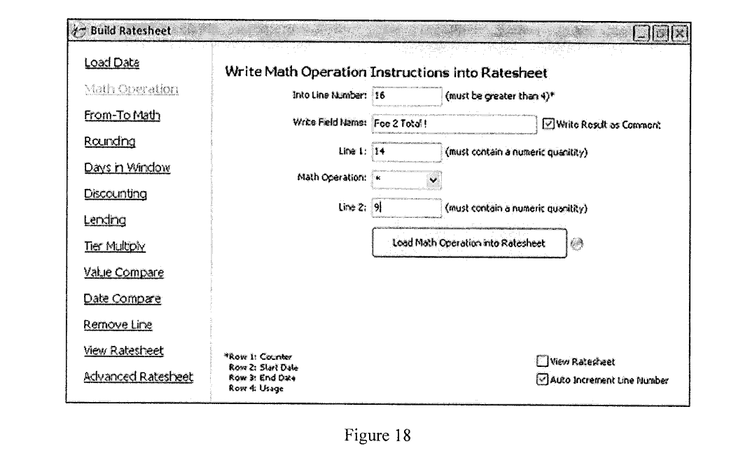

In FIGS. 13-15, and 17-18, the user wishes to perform math operations on the loaded data. The screen is reached by selecting the “Math Operation” hyperlink from the left hand pane of the window. In FIG. 13, for example, the user is entering the result of the math operation into text box 216, in this case, calculation line 11. The math operation of FIG. 13 is a multiplication, as specified in text box 212, in which the values of the operands are calculation line 5, specified in text box 210, and calculation line 10 specified in text box 214. The desired math operation entered into text box 212 is selectable from a pull-down menu. Similar calculations are being entered on calculation lines 12-13 in FIGS. 14 and 15 respectively and calculation lines 15-16 in FIGS. 17 and 18 respectively.

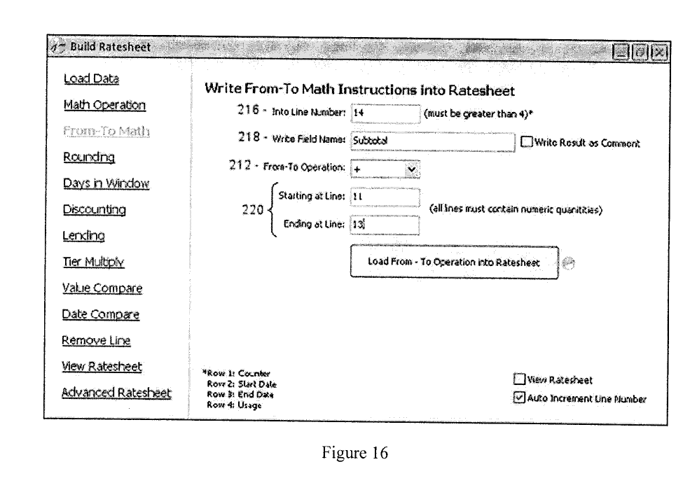

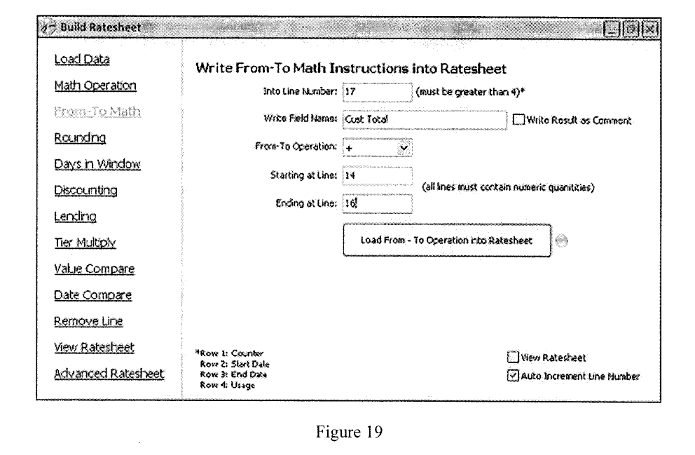

In FIG. 16 a “from-to” math operation is being entered. This is a math operation that may use multiple operands from a range of lines. For example, the math operation specified in text box 212 in FIG. 16 is a sum, and the operands are a range of calculation lines specified in text boxes 220, specifically calculation lines 11 through 13. The result of the sum is stored in the destination, specified in text box 216, in this case calculation line 14, and assigned a name, entered into text box 218, in the output table, in this example “Subtotal”. FIG. 19 shows a similar calculation.

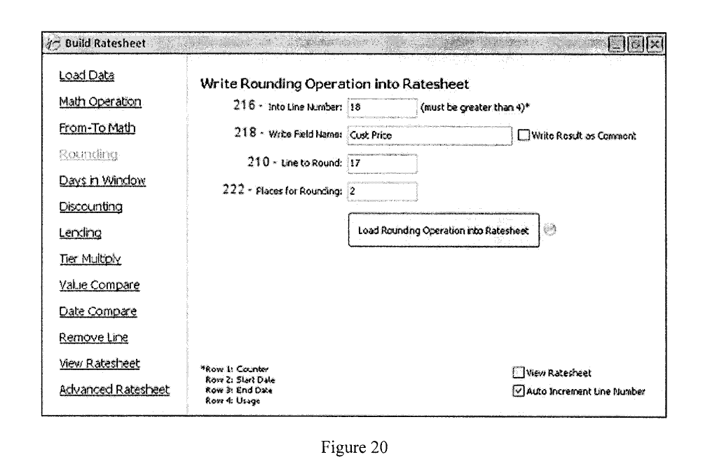

FIG. 20 depicts a rounding operation. This screen is reached by selecting the “Rounding” hyperlink from the left pane in the window. In this case, the destination text box 216 is specified as calculation line 18 and given the name specified in text box 218, “Cust_Price”, to be assigned to the result. The first operand, specified in text box 210, is to be assigned as calculation line 17, and text box entry 222 allows the user to specify the number of places to which calculation line 17 is to be rounded.

Note that all of the entry screens have a “Load” button at the bottom. Selecting this button signifies that the user has completed the input to the interface and the instructions should be loaded into user language interface 200, and that meta-language 300, should be written into storage 400. When this happens, the screen is set up for the next operation.

Similar screens apply for the remainder of the hyperlinks in the left pane of the window, but are not explicitly shown here. These may include, but are not limited to, functions to determine days within a specific time period, commands to calculate the time value of money, tier multiplication functions, date comparisons and value comparisons. Note also that in an alternate embodiment of the invention, the user input fields of the preceding screens samples could be replaced by drag and drop icons, which can be arranged in a flow-chart like manner.

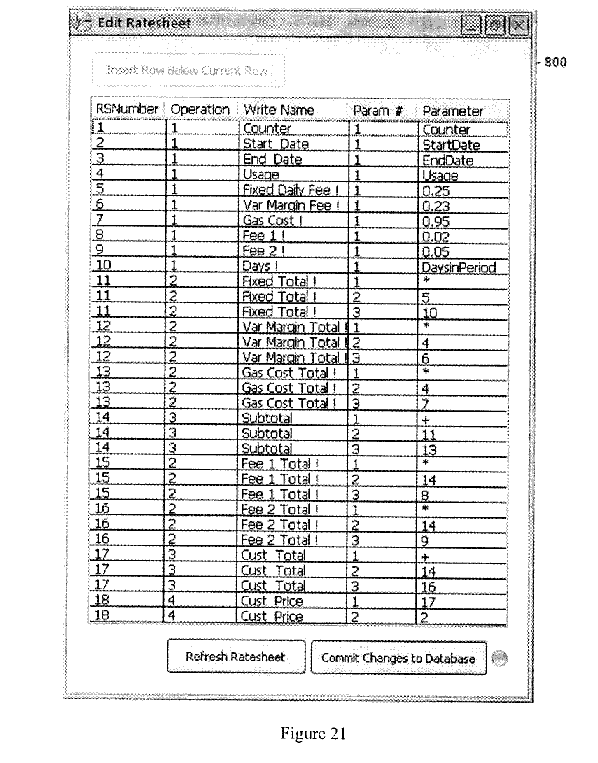

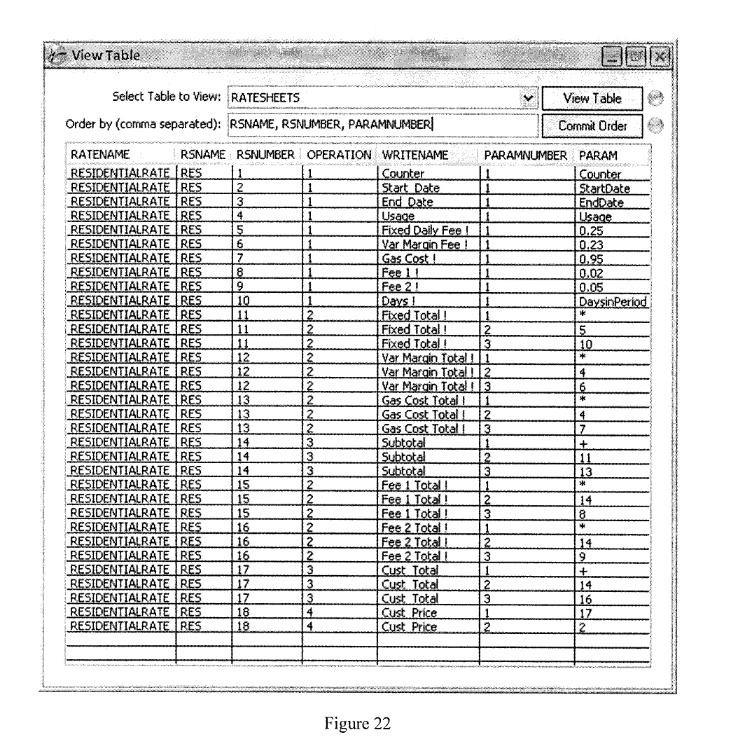

FIG. 21 is a sample screen depicting a prototype implementation of a screen 800 showing a translation of the user input commands 100 from FIGS. 7-20 into meta-language 300. This user interface screen can also be used to directly edit the parameters of the entered user input commands 100. FIG. 22 shows meta-language 300, previously shown in screen 800, as it is stored in storage 400, in this case as a table in a database. It should be noted that direct entry of the meta-language by into the database at this step is possible. Therefore, user interface 200 can be bypassed by a skilled user. A skilled user can also edit input commands in database storage 400 at this point.

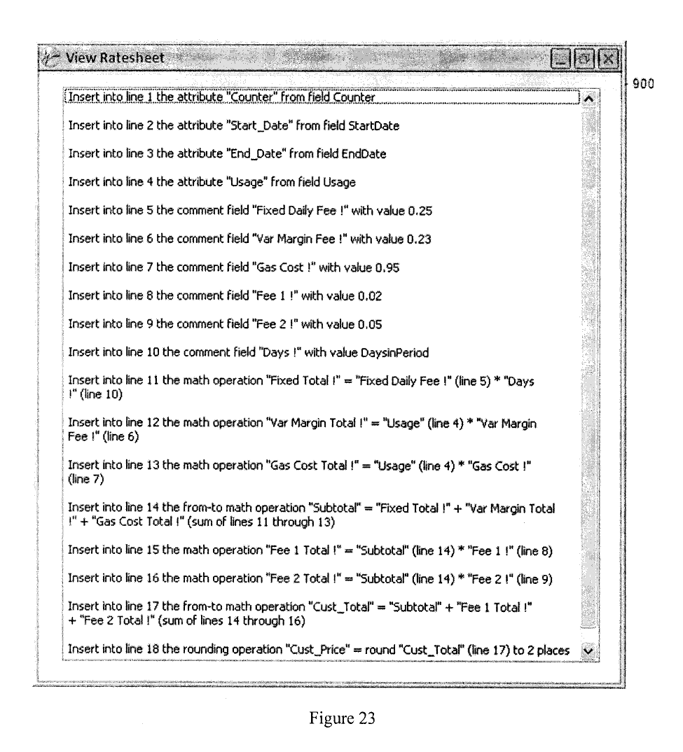

FIG. 23 is a sample implementation of screen 900, depicted conceptually in FIG. 6, which displays the user input commands 100 in a natural language of the user's choice, in this case English.

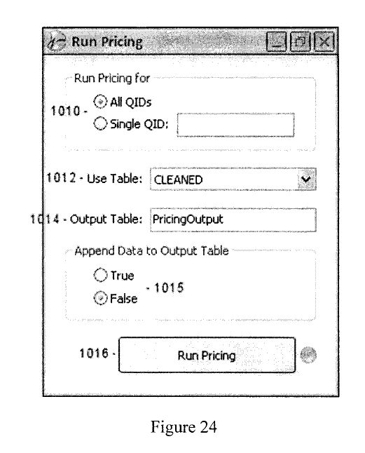

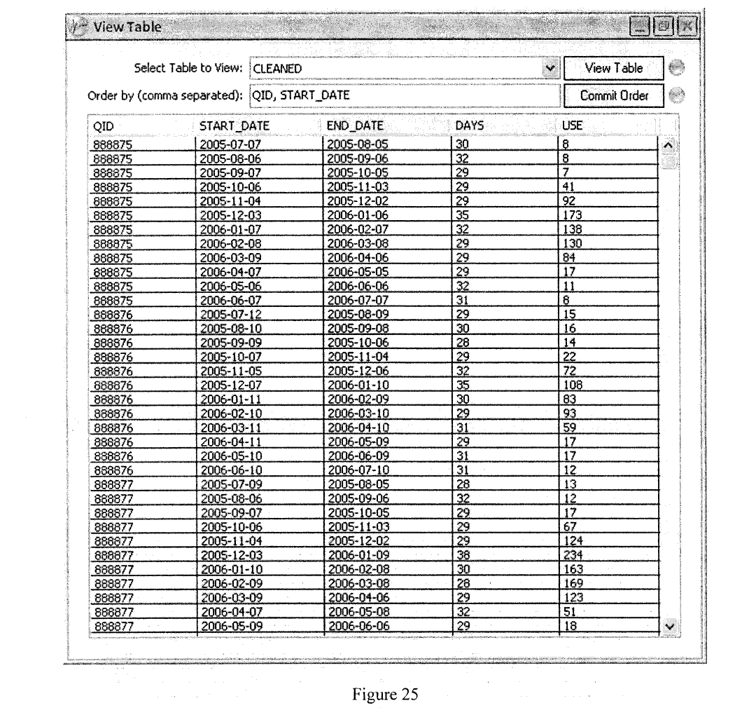

FIG. 24 is a sample screen depicting a prototype implementation of a user interface to execution engine 202, shown in FIG. 2. In this screen, the user can specify, in box 1010, whether the previously created program should run on one record in the database (perhaps for testing), or on the whole database table. In other implementations, it should be possible to allow the user to specify various ranges of records that the program should be executed against, or to allow the user to enter database search criteria, and have the program executed against the results of the search. Also contemplated is a window showing the input database table from which the user may manually select records with the computer's pointing device. Although these options are not shown, the invention is meant to allow the user to select any set of records in the database to use as input data for the operations. The values stored in the database table are shown in FIG. 25.

In box 1012, the user is able to specify the database table that the input records are to be drawn from, in this case, the table shown in FIG. 25, and, in text box 1014, the database table to which the result are to be written. In box 1015, the user may choose to append data to the specified output table or to overwrite existing data in the output table.

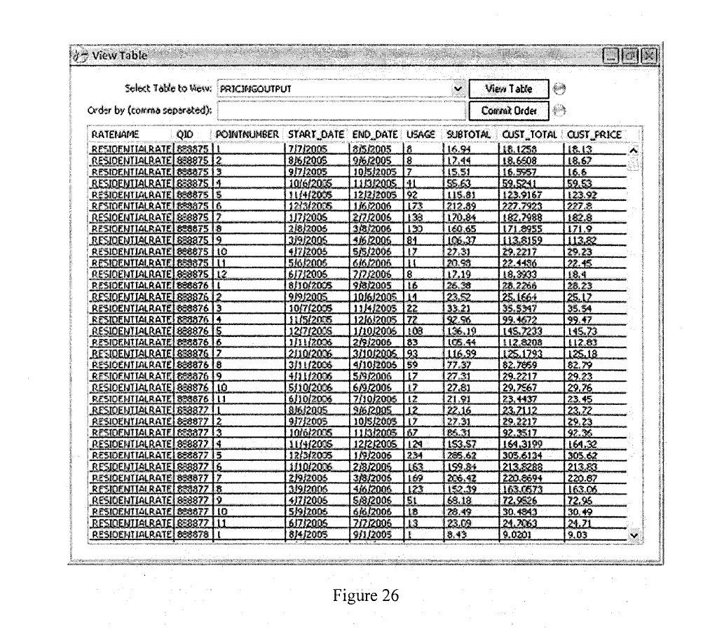

The user executes the program by selecting the “Run” button 1016. FIG. 26 shows the output database table after the conclusion of the program run.

The detailed description provided is represented largely in terms of high-level computer languages, processes and symbolic representations of operations by conventional computer components, including processing units, memory storage devices, display devices and input devices. These processes and operations may utilize conventional computer components in a distributed computing environment, including remote file servers, remote computer servers, multiple and distributed databases, and remote memory storage devices, however, the invention is meant to be hardware independent. Preferably, each of these distributed conventional computing components is accessible by a processing unit via a communications network.

Likewise, the present embodiment of the invention includes a computer language and system that embodies the functions described herein and is illustrated in the figures. The sample screens included herein are meant to be exemplary in nature, and are not meant to limit the invention to the particular implementation shown. It should be apparent to one of skill in the art that there could be many different ways of implementing the invention, and that the invention should not be construed as limited to any one set of computer program instructions or screen configurations.

Although exemplary embodiments of the present invention will generally be described in the context of Microsoft Windows, Real Basic, Oracle and Excel, those skilled in the art will also recognize that this invention can also be implemented in conjunction with other operating systems, high level languages, proprietary databases and spreadsheets for other types of computers.

We claim:

1. A method of performing sequential calculations on data stored in a database comprising the steps of:
a. providing a user interface allowing entry of a plurality of steps in a calculation;
b. translating said plurality of steps into a meta-language;
c. interpreting said meta-language into a list of procedural commands for the retrieval, manipulation and storage of data; and
d. executing said list of procedural commands against a set of data from one or more databases and storing the results of the execution of said list of procedural commands in one or more databases;
e. wherein said user interface allows the entry of said steps in said calculation for the manipulation of said one or more databases without knowledge of the structure or schema of said databases.

2. The method of claim 1 wherein said user interface comprises a calculator-like interface utilizing push buttons and text boxes to specify each of said steps in said calculation.

3. The method of claim 1 wherein said interface is a visual interface comprising:
a. a means for selecting a type of operation to be entered;
b. a plurality of screens which are customized for each type of operation, said customized screens allowing the specification of operands and operators for each operation of said selected type.

4. The method of claim 3 wherein said means for selecting a type of operation is selected from a group of interface widgets consisting of hyperlinks, pushbuttons, radio buttons, text boxes, menus, pull downs, pass over links and windows.

5. The method of claim 3 wherein said visual interface further comprises a means of sequencing said entered user steps.

6. The method of claim 3 wherein said visual interface further comprises a means of assigning a name to the result of said operation.

7. The method of claim 3 wherein said operands can be specified as references to the results of other operations.

8. The method of claim 1 further comprising the step of displaying a listing of said meta-language translation of said user-entered steps.

9. The method of claim 8 wherein said meta-language listing shows said user-entered steps as an ordered list of meta-language translations.

10. The method of claim 1 further comprising the step of displaying a natural language description of each of said user-entered steps.

11. The method of claim 1 wherein said user interface comprises a drag and drop interface utilizing icons which can be dragged into relative positions with respect to other icons and connected via lines to indicate the desired calculation.

12. The method of claim 11 further comprising the step of displaying a listing of said meta-language translation of said user-entered steps.

13. The method of claim 11 further comprising the step of displaying a natural language description of each of said user-entered steps.

14. A system for accessing a database comprising:
a. an interface, for entering user commands;
b. a translator, for translating said user commands into a meta-language;
c. a storage, for storing said meta-language; and
d. an execution engine, for interpreting said meta-language into low-level commands for the retrieval, manipulation and storage of data in one or more databases.

15. The system of claim 14 wherein said interface is a visual interface comprising:
a. a means for selecting a type of operation to be entered; and
b. customized screens for each type of operation which allow the specification of operands and operators for each operation of said selected type.

16. The system of claim 15 wherein said means for selecting a type of operation is selected from a group of interface widgets consisting of hyperlinks, pushbuttons, radio buttons, text boxes, menus, pull downs, pass over links, and windows.

17. The system of claim 14 wherein said visual interface further comprises a means of sequencing said entered user commands

18. The system of claim 14 wherein said visual interface further comprises a means of assigning a name to the result of said operation.

19. The system of claim 15 wherein said operands can be specified as references to the results of other operations.

20. The system of claim 15 further comprising of a display containing a listing of the said meta-language translation of said user-entered commands.

21. The system of claim 20 wherein said meta-language listing shows said user-entered commands as an ordered list of operations.

22. The system of claim 15 further comprising of a display containing a listing of a natural language description of each of said user-entered commands.

23. The system of claim 22 wherein said natural language listing shows said user-entered commands as an ordered list of operations.

24. The system of claim 15 wherein said operands can be specified as references to specific fields in a database record.

25. The system of claim 15 wherein the result of said operation can be specified as a reference to a specific field in a database record.

26. The system of claim 17 wherein said sequence of user-entered commands can be executed against a set of one or more records from a database.

27. The system of claim 26 wherein said user can specify the records in said set.

28. The system of claim 27 wherein each user-entered command in said sequence can be executed on all records specified in said set of records before moving to the next command in said sequence.

29. The system of claim 28 wherein the results of executed commands can be saved in a buffer for access by subsequent commands.

30. The system of claim 26 wherein the results of any operation in said sequence of user-entered commands can be saved as a specific field in a record in a database.

31. The system of claim 20 wherein said commands may be edited directly in said meta-language listing.

32. The system of claim 15 wherein said operands can be entered into a text field or selected from a menu of available operands and further wherein said operands of the specified type can be selected from a menu of available operands.

33. The system of claim 14 wherein said operands and operators are represented as icons which can be dragged into relative positions with respect to other icons and connected via lines to indicate the desired operation.
